(19) United States
(12) Patent Application Publication
(10) Pub. No.: US 2010/0242287 A1
(43) Pub. Date: Sep. 30, 2010

(54) Three-dimensional pocketknife puzzle

(76) Inventor: Eugene Gregg Jameson, Belton, SC (US)

Correspondence Address: MONAHAN & MOSES, LLC, 13-B W. WASHINGTON ST., GREENVILLE, SC, 29601, US

(21) Appl. No.: 12/661,731

(22) Filed: Mar. 23, 2010

Related U.S. Application Data
(60) Provisional application No. 61/162,890, filed on Mar. 24, 2009.

(51) Int. Cl. B26B 1/06; B26B 5/00; A63F 9/08

(52) U.S. Cl. 30/157; 30/155; 273/156

(57) ABSTRACT

A pocketknife puzzle or kit is provided having a blade and spring, sandwiched between two handle sections and held in place by three pins. The pins are held in place by friction, resulting from the tension of the spring against the pivoting end of the blade. The pocketknife may be assembled and disassembled without tools.

This application claims priority to provisional patent application Ser. No. 61/162,890, filed Mar. 24, 2009.

### BACKGROUND OF THE INVENTION

This invention relates to a pocketknife puzzle or kit for making a pocketknife. The component parts may be assembled into a pocketknife, useful as a toy, letter opener or the like, and then disassembled again, as desired.

Pocketknives useful as tools are well known in the prior art. The blade, spring and handles are made of metal. Rivets are employed to hold the component parts together. The pocketknives are sold assembled and are intended to remain assembled. Such a pocketknife may be disassembled only with difficulty, such as by removing the rivets with a punch, thereby damaging or destroying them.

Prior art toy pocketknives have typically been sold pre-assembled and are not intended to be disassembled. Furthermore, many toy pocketknives lack features, such as a spring, to engage the pivoting end of the blade and hold the blade in a desired position, for example, open or closed.

### SUMMARY OF THE INVENTION

The present invention is a three-dimensional puzzle or kit for making a pocketknife. The component parts of the pocketknife are a blade, a spring, first and second handle sections and three cylindrical fasteners. The blade has a pivoting end, with a hole therein, and a swinging end, opposite the pivoting end. The pivoting end of the blade may have a cam-shaped outer surface (cam surface). The blade need not be pointed at the swinging end or sharp, but it can be pointed and sharpened, as desired.

The spring has an anchoring end, with a first hole therein, a deflecting end, opposite the anchoring end, and a second hole, positioned between the anchoring end and the deflecting end. The deflecting end of the spring is urged against the pivoting end of the blade, when the pocketknife is assembled.

The handle of the pocketknife is in two sections. The first handle section has a first end, with a first hole therein, a second end, opposite the first end, with a second hole therein, and a third hole, positioned between the first and second holes. The second handle section has a first end, with a first hole therein, a second end, opposite the first end, with a second hole therein, and a third hole, positioned between the first and second holes. Three cylindrical fasteners are provided, which are configured to engage the first, second and third holes in the first and second handle sections.

When the pocketknife is assembled, the blade and spring are sandwiched between the first and second handle sections. One of the cylindrical fasteners extends through the first holes in the handle sections and the hole in the pivoting end of the blade. The second cylindrical fastener extends through the second holes in the handle sections and the hole in the anchoring end of the spring. The third cylindrical fastener extends through the third holes in the handle sections and the second hole in the spring.

In one embodiment of the invention, the cylindrical fasteners are selected to allow the pocketknife to be assembled and disassembled, multiple times and without damage to the fasteners. By way of example, the cylindrical fasteners may be metal pins or bolts, the bolts having a threaded end to engage a nut. The use of pins has the advantage that the component parts may be assembled to make a pocketknife, and disassembled again, without the use of tools. The pins are held in place solely by frictional engagement, as the spring is under tension itself and the spring applies tension to the pivoting end of the blade.

In one embodiment of the invention, the blade, spring, first and second handles, and first, second and third cylindrical fasteners are provided unassembled in a package. This provides a child with the challenge of assembling the component parts to make a pocketknife, by following the instructions provided therewith. Preferably, the package is re-usable and is proportioned to store both the unassembled component parts or the assembled pocketknife.

### BRIEF DESCRIPTION OF THE DRAWINGS

FIG. 1 is an exploded view of the pocketknife.

FIG. 2 is a perspective view of the assembled pocketknife.

FIG. 3 is a perspective view of an alternative embodiment of the cylindrical fasteners used to hold the pocketknife together, namely bolts and nuts.

FIG. 4 is an example of suitable packaging for the component parts of the pocketknife, namely a re-usable tin box.

### DETAILED DESCRIPTION OF THE INVENTION

Without intending to limit the scope of the invention, the preferred embodiments and features are hereinafter set forth.

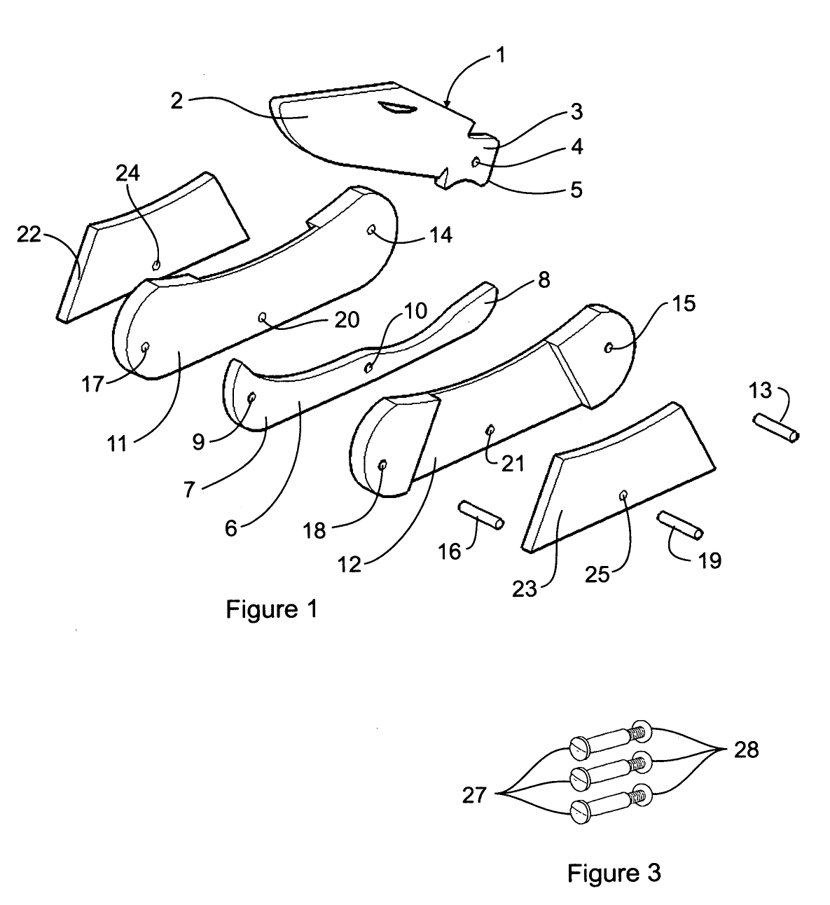

FIG. 1 is an exploded view showing the individual component parts of the pocketknife puzzle and how the components fit together. Blade 1 has a swinging end 2 and a pivoting end 3, shown with a point. Pivoting end 3 has a hole 4 and a cam surface 5.

Spring 6 has an anchoring end 7 and a deflecting end 8. Spring 6 has a first hole 9 in the anchoring end 7 and a second hole 10 between the anchoring end 7 and the deflecting end 8. The first hole 9 and second hole 10 are spaced apart to provide leverage, when the parts are assembled, whereby deflecting end 8 may be resiliently deflected, but spring 6 does not pivot about hole 10.

Blade 1 and spring 6 are sandwiched between handle sections 11 and 12, whereby deflecting end 8 of spring 6 is urged against cam surface 5, as blade 1 is pivoted. The force applied to the pivoting end 3 of blade 1 by spring 6 holds blade 1 in position (closed or open), as well as creates sufficient force to frictionally engage pin 13, which is inserted through holes 14 and 15 in handles 11 and 12, respectively, and hole 4 in blade 1.

Pin 16 is inserted through hole 17 in handle 11, hole 9 in spring 6 and hole 18 in handle 12. Pin 19 is inserted through hole 20 in handle 11, hole 10 in spring 6 and hole 21 in handle 12. The force applied to the deflecting end 8 of spring 6 by the pivoting end 3 of blade 1 is transmitted along spring 6 creating sufficient force to frictionally engage pins 16 and 19, when the parts are assembled.

Optionally, inlays 22 and 23 are provided, which conform to recesses in the outer surfaces of handles 11 and 12, respectively. Inlays 22 and 23 are provided with holes 24 and 25, respectively, which allows the inlays to fit over pin 19. Inlays 22 and 23 are not frictionally engaged by pin 19, but can be glued to the handles.

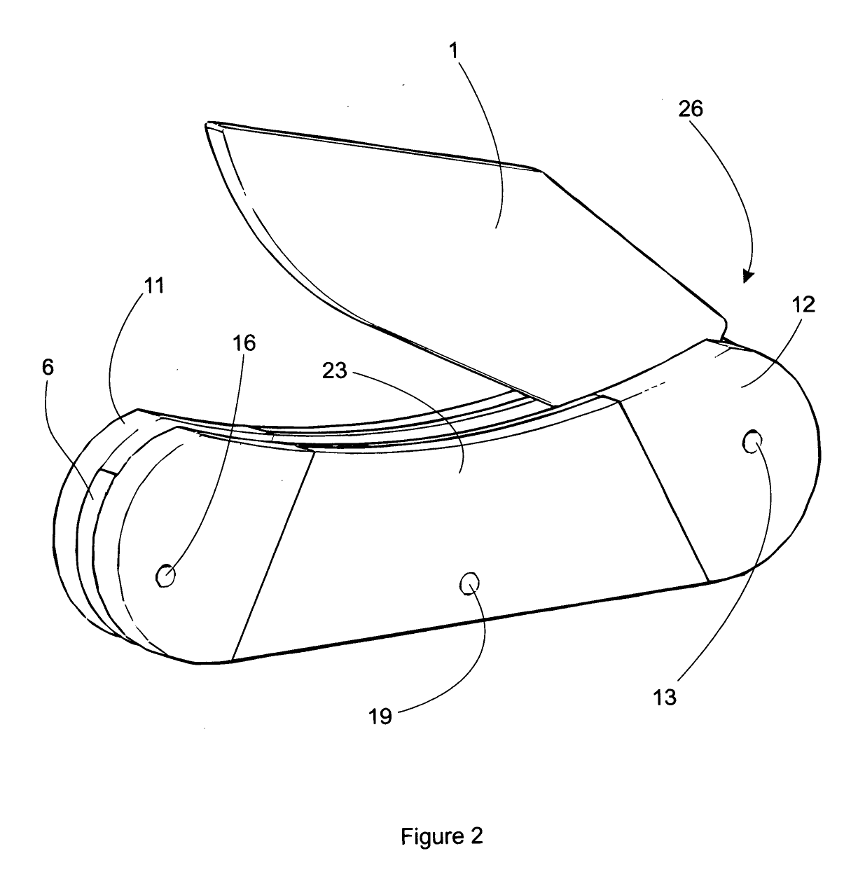

Referring to FIG. 2, the assembled pocketknife 26 is shown. In one embodiment of the invention, each of pins 13, 16 and 19 is a metal rod having a uniform diameter along its length. Accordingly, the pins and other parts of the pocketknife (blade, spring and handles) can slide relative to each other, allowing the pocketknife to be assembled and disassembled without tools, and without damaging the pins.

In an alternative embodiment, pins 13, 16 and 19 may be replaced by bolts 27 and nuts 28, shown in FIG. 3. For example, nuts 28 may be inserted in handle 11 or 12, to facilitate assembly. The bolts 27 can be unscrewed to disassemble the knife, as desired, without damaging the bolts and nuts. The cylindrical fasteners may also be a non-metal dowel or peg, or metal cotter pin.

The blade, spring and handles may be made of the same or different material. By way of example, the material of construction for the blade, spring and handle may be selected from wood, thermoplastic resin, thermosetting resin or metal. The resin may be a composite, having a filler or fiber reinforcement incorporated therein. Wooden parts may be manufactured using a computer guided laser or router. For use as a child's puzzle, the blade, spring and handle are preferably non-metal.

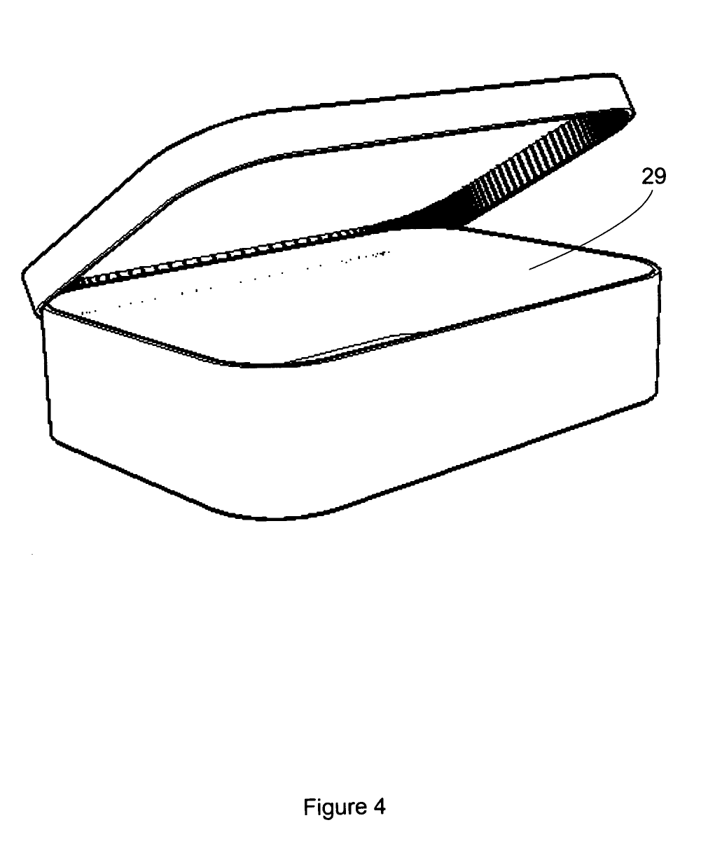

The parts of pocketknife 26 can be sold unassembled in a package. The term “package” is intended to encompass containers, such as a tin box 29, shown in FIG. 4 and other re-usable metal, textile and synthetic resin containers, which can accommodate all of the parts or the assembled pocketknife, as well as disposable packaging such as plastic bags or molded plastic sheets.

Optionally, the pocketknife kit components can be glued together for permanency. The blade can be left dull or can be sharpened to a point. The blade may be waxed for ease of opening and closing of the blade. The components may be painted, stained or varnished before or after assembly.

The invention may be further understood by reference to the following claims.

What I claim is:

1. A kit for a pocketknife comprising:
(a) a blade, having a pivoting end, with a hole therein, and a swinging end, opposite the pivoting end;
(b) a spring, having an anchoring end, with a first hole therein, a deflecting end, opposite the anchoring end, and a second hole, positioned between the anchoring end and the deflecting end;
(c) a first handle section, having a first end, with a first hole therein, a second end, opposite the first end, with a second hole therein, and a third hole, positioned between the first and second holes;
(d) a second handle section, having a first end, with a first hole therein, a second end, opposite the first end, with a second hole therein, and a third hole, positioned between the first and second holes; and
(e) first, second and third cylindrical fasteners, shaped to engage the first, second and third holes in the first and second handles; and
(f) wherein the blade, spring, first and second handles, and first, second and third cylindrical fasteners are provided unassembled in a package.

2. The kit of claim 1, wherein the first, second and third cylindrical fasteners are pins, and wherein the blade, spring, first and second handles, and first, second and third pins can be assembled into a pocketknife without tools.

3. The kit of claim 1, wherein the first, second and third cylindrical fasteners are pins, and wherein the blade, spring, first and second handles, and first, second and third pins can be assembled into a pocketknife without tools and disassembled without tools.

4. The kit of claim 3, wherein the assembled pocketknife is held together solely by the frictional engagement of the first, second and third pins in the blade, spring and first and second handles.

5. The kit of claim 4, wherein the pivoting end of the blade has a cam shaped outer surface that maintains tension against the deflecting end of the spring, in the assembled pocketknife.

6. The kit of claim 1, wherein the blade, spring, and first and second handles are non-metal.

7. The kit of claim 1, wherein the blade, spring, and first and second handles are made of wood.

8. A pocketknife comprising:
(a) a first handle section, having a first end, with a first hole therein, a second end, opposite the first end, with a second hole therein, and a third hole, positioned between the first and second holes;
(b) a second handle section, having a first end, with a first hole therein, a second end, opposite the first end, with a second hole therein, and a third hole, positioned between the first and second holes;
(c) a blade, having a pivoting end, with a hole therein, and a swinging end, opposite the pivoting end, wherein the pivoting end of the blade is sandwiched between the first and second handles;
(d) a first pin, positioned in the first hole of the first handle, the hole in the pivoting end of the blade and the first hole of the second handle;
(e) a spring, having an anchoring end, with a first hole therein, a deflecting end, opposite the anchoring end, and a second hole, positioned between the anchoring end and the deflecting end, wherein the spring is sandwiched between the first and second handles, with the deflecting end of the spring engaging the pivoting end of the blade;
(f) a second pin, positioned in the second hole in the first handle, the first hole in the anchoring end of the spring and the second hole in the second handle;
(g) a third pin, positioned in the third hole in the first handle, the second hole in the spring and the third hole in the second handle; and
(h) wherein the pocketknife is held together solely by the frictional engagement of the first, second and third pins in the blade, spring and first and second handles.

9. The pocketknife of claim 8, wherein the blade, spring, first and second handles, and first, second and third pins can be disassembled without tools.

10. The pocketknife of claim 8, wherein the pivoting end of the blade has a cam shaped outer surface that maintains tension against the deflecting end of the spring.

11. The pocketknife of claim 8, wherein the first, second and third pins can be removed from the pocketknife without damaging the pins.

12. The pocketknife of claim 8, wherein the blade, spring, and first and second handles are non-metal.

13. The pocketknife of claim 8, wherein the blade, spring, and first and second handles are made of wood.

14. A three-dimensional puzzle comprising:
(a) a blade, having a pivoting end, with a hole therein, and a swinging end, opposite the pivoting end;
(b) a spring, having an anchoring end, with a first hole therein, a deflecting end, opposite the anchoring end, and a second hole, positioned between the anchoring end and the deflecting end;
(c) a first handle section, having a first end, with a first hole therein, a second end, opposite the first end, with a second hole therein, and a third hole, positioned between the first and second holes;
(d) a second handle section, having a first end, with a first hole therein, a second end, opposite the first end, with a second hole therein, and a third hole, positioned between the first and second holes; and
(e) first, second and third cylindrical fasteners, shaped to be inserted into the first, second and third holes in the first and second handles;
(f) wherein the blade, spring, first and second handles, and first, second and third cylindrical fasteners can be assembled to create a pocketknife; and
(g) wherein the blade, spring, and first and second handles are non-metal.

15. The puzzle of claim 14, wherein the first, second and third cylindrical fasteners are selected from the group consisting of pins and bolts.

16. The puzzle of claim 14, wherein the blade, spring, first and second handles, and first, second and third cylindrical fasteners can be assembled to create a pocketknife, without forming a rivet.

17. The puzzle of claim 14, wherein the blade, spring, and first and second handles are wood.

18. The puzzle of claim 14, wherein the first, second and third cylindrical fasteners are pins, which can be slid into the first, second and third holes in the first and second handles, when the pocketknife is assembled, and slid out of the first, second and third holes in the first and second handles, when the pocketknife is disassembled.

19. The puzzle of claim 18, wherein the blade, spring, first and second handles, and first, second and third cylindrical fasteners can be assembled to create a pocketknife without the use of tools.

20. The puzzle of claim 19, wherein the assembled pocketknife is held together solely by the frictional engagement of the first, second and third pins in the blade, spring and first and second handles.
